(19) United States
(12) Patent Application Publication
(10) Pub. No.: US 2016/0153627 A1
(43) Pub. Date: Jun. 2, 2016

(54) ATTACHMENT MECHANISM FOR SUSPENDING ORNAMENTAL OBJECTS

(71) Applicant: Perfect Republic, LLC, Potomac, MD (US)

(72) Inventor: Peter Dennis, Potomac, MD (US)

(73) Assignee: Perfect Republic, LLC, Potomac, MD (US)

(21) Appl. No.: 14/558,519

(22) Filed: Dec. 2, 2014

(51) Int. Cl. F21S 4/00; F21V 33/00; F21V 23/00

(52) U.S. Cl. CPC F21S 4/001; F21V 23/003; F21V 33/0004; F21W 2121/00

(57) ABSTRACT

An ornamental device, the device including a string of electrically-illuminated lights having a plurality of lighting units; and respective attachment mechanisms coupled to each of the lighting units of the string of electrically-illuminated lights and configured to securely hold ends of sticks of stick-based candies therein and incorporated into each lighting unit on the string of electrically-illuminated lights.

### BACKGROUND OF THE INVENTION

1. Field of the Invention

The present invention generally relates to holiday ornaments, and more particularly to mechanisms and devices by which ornaments, such as stick-based candies, such as rock candy and lollipops, and the like, can be easily hung in an inverted position for ornamental applications, either individually or from a string of powered lights, and the like.

2. Discussion of the Background

Over the years, various types of Christmas tree ornaments and decorations have been developed, including electric lights, glass ornaments, tinsel, and the like, that can be hung or otherwise attached to branches of Christmas trees, and the like. However, such ornaments are not robust with respect to attachment of objects other than electric lights, glass ornaments, tinsel, and the like.

Therefore, there is a need for mechanisms and devices to enable attachment of objects other than electric lights, glass ornaments, tinsel, and the like.

### SUMMARY OF THE INVENTION

The above and other needs are addressed by the present invention, which enables edible, stick-based candies (e.g., rock candy, lollypops, etc.) to be hung in an inverted, ornamental fashion from the branches of any suitable Christmas tree, or other supporting structure, or from each lighting unit in a string of ornamental lights, and the like. The attachment mechanism can be integrated directly into the inedible stick of a candy, configured as an individual component capable of suspending a stick-based candy in an inverted position from a supporting structure, integrated within each lighting unit in a string of ornamental lights, and the like.

An ornamental device, the device including a string of electrically-illuminated lights having a plurality of lighting units; and respective attachment mechanisms coupled to each of the lighting units of the string of electrically-illuminated lights and configured to securely hold ends of sticks of stick-based candies therein and incorporated into each lighting unit on the string of electrically-illuminated lights.

The sticks of the stick-based candies are made from a light-conducting material; and each of the lighting units and the respective attachment mechanisms are configured so that light from the lighting units is projected through the sticks of stick-based candies to illuminate the sticks.

The device further includes a programmable control box configured to allow for programming of color, brightness, and patterns of lights transmitted by the lighting units.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which;

FIG. 1 is a diagram for illustrating mechanisms and devices by which ornaments, such as stick-based candies, and the like, can be easily hung in an inverted position for ornamental applications, according to the present invention;

FIG. 2 is a diagram illustrating the use of a static hook as the attachment mechanism, and how the hook can be incorporated directly within the stick of any suitable stick-based candy, capable of suspending stick-based candies in an inverted position from a supporting structure, according to the present invention;

FIG. 3 is a diagram illustrating the use of a twist-tie as the attachment mechanism, and how the twist-tie can be incorporated directly within the stick of any suitable stick-based candy, capable of suspending stick-based candies in an inverted position from a supporting structure, according to the present invention;

FIG. 4 is a diagram illustrating integration of a small eye into the stick of any suitable stick-based candy, enabling stick-based candies in an inverted position from a supporting structure with use of any suitable standard Christmas tree hook, string, or ribbon as the attachment mechanism, according to the present invention;

FIG. 5 is a diagram illustrating the use of a hook as the attachment mechanism, and the use of a dual-prong hook as a connector mechanism, capable of suspending stick-based candies that have a ball incorporated into the stick's design, by suspending the ball at the end of the candy's stick between the dual-prong hooks, in an inverted position from a supporting structure, according to the present invention;

FIG. 6 is a diagram illustrating use of a female-port attachment mechanism that most stick-based candies can be inserted into, enabling stick-based candies in an inverted position from a supporting structure, according to the present invention;

FIG. 7 is a diagram illustrating use of a male attachment mechanism that can be inserted into the hollow tube of some stick-based candies, using friction between the male pin and the sides of the hollow tube, to suspend stick-based candies in an inverted position from a supporting structure, according to the present invention;

FIG. 8 is a diagram illustrating incorporation of the female attachment mechanism adjacent to each lighting unit in a string of powered lights, to suspend and externally illuminate stick-based candies in an inverted position from a supporting structure, according to the present invention; and

FIG. 9 is a diagram illustrating incorporation of the female attachment mechanism into each lighting unit in a string of powered lights, whereby the light(s) are located immediately above the female attachment port, allowing for light to be projected through the shaft of any suitable stick-based candy made on sticks constructed of materials which allow for the transmission of light through the shaft of the stick, to suspend and externally illuminate stick-based candies in an inverted position from a supporting structure, according to the present invention.

### DETAILED DESCRIPTION OF THE ILLUSTRATIVE EMBODIMENTS

The present invention includes recognition that centuries ago Christmas trees were traditionally decorated with edibles, such as apples, nuts and other food during the holiday season. With time, decorations became more elaborate, and the traditional edible decorations were later replaced with electric lights, glass ornaments, and tinsel, all of which were designed so that they may be hung or otherwise attached to the branches of Christmas trees easily and conveniently. However, certain types of ornaments, such as stick-based candies, and the like, would be ideal as edible ornamentation when hung in an inverted position from a Christmas tree, and the like. The present disclosure describes suitable mechanisms and devices for connecting such stick-based candy to a supporting branch of Christmas or any other suitable structure, and the like. For example, rock candy, and the like, can be suspended in an inverted position, and bear a resemblance to icicles, and the like. Another example can include lollipops, which can wrapped to look like Christmas ornaments, and the like, and hung from the branches of a Christmas tree, and the like.

Generally, the present disclosure includes attachment mechanisms devices that allow for ornaments, such as stick-based candies, such as rock candy and lollipops, and the like, to be suspended in an inverted position from a supporting structure of a Christmas tree, and the like, for ornamental purposes, and the like. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

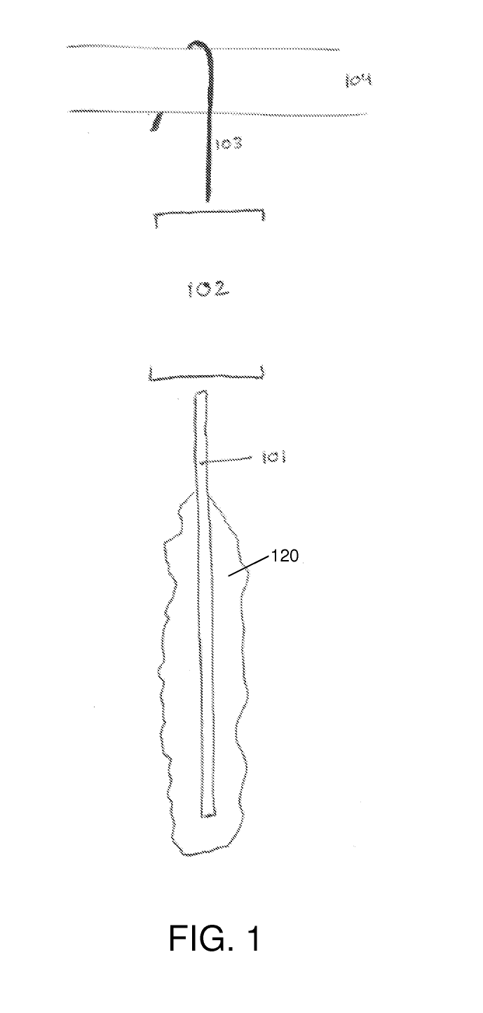

Referring now to the drawings, wherein like referring numerical designate identical or corresponding parts throughout the several views, and more particularly to FIG. 1, thereof there is illustrated mechanisms and devices by which ornaments, such as stick-based candies, and the like, can be easily hung in an inverted position for ornamental applications, according to the present invention.

In FIG. 1, stick 101 represents the inedible stick of stick-based candies having candy portion 120. Hook 103 represents the attachment mechanism used to suspend the stick-based candy from supporting structure 104, such as the branch of a Christmas tree, and the like. Connector 102 represents the structural bridge between hook 103 and stick 101.

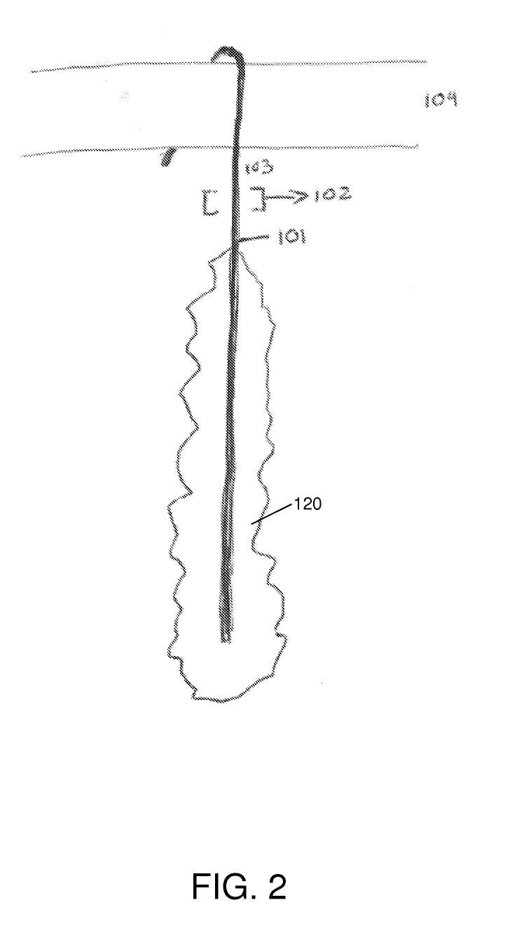

FIG. 2 is a diagram illustrating the use of hook 103 as the attachment mechanism, and how hook 103 can be incorporated directly into stick 101 of any suitable stick-based candy as a static feature. In FIG. 2, advantageously, such attachment mechanism can include utilizing the strength of the common material used in the manufacture of both the stick 101 and hook 103 to serve the purpose of connector 102, capable of suspending stick-based candies in an inverted position from a supporting structure 104.

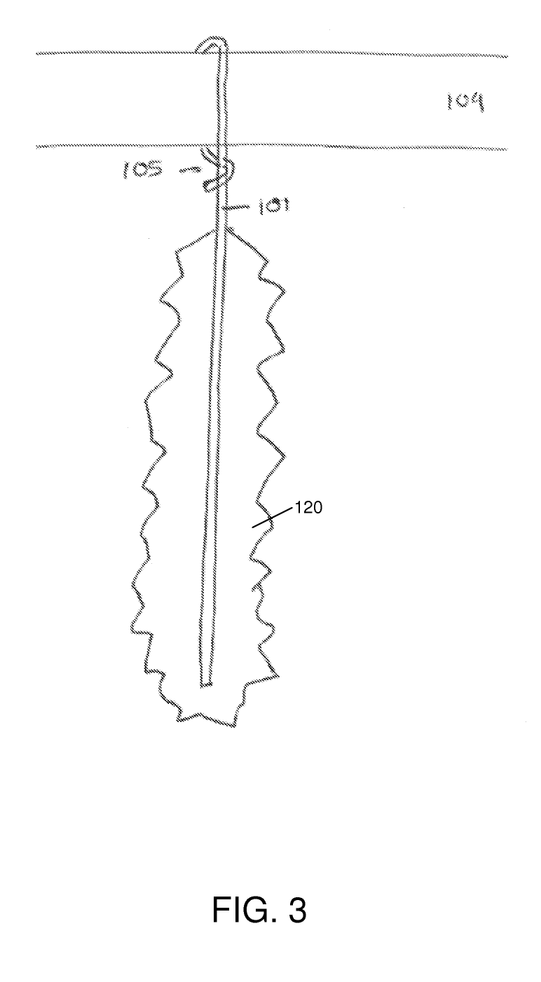

FIG. 3 is a diagram illustrating the use of twist-tie 105 as the attachment mechanism as an alternative to hook 103. In FIG. 3, the twist-tie 105 can be integrated directly into stick 101 of any suitable stick-based candy. Advantageously, such attachment mechanism can include utilizing the strength of the common material used in the manufacture of both the stick and hook to serve the purpose of connector 102, capable of suspending stick-based candies in an inverted position from a supporting structure 104.

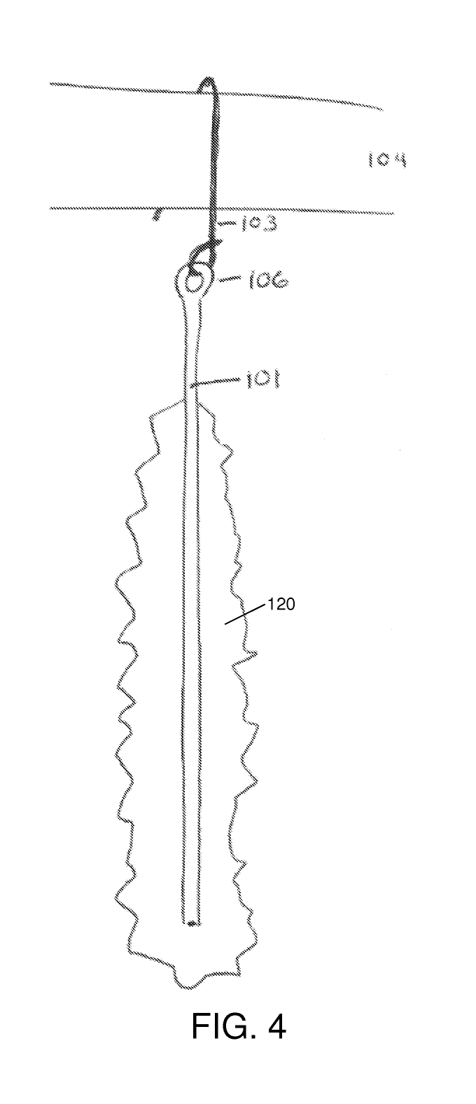

FIG. 4 is a diagram illustrating integration of a small eye 106 integrated into stick 101 of any suitable stick-based candy. In FIG. 4, the mechanism enables stick-based candies to be suspended in an inverted position from supporting structure 104 with use of any suitable standard Christmas tree hook 103, string, or ribbon, and the like, as the attachment mechanism, and with the small eye 106 as the connector.

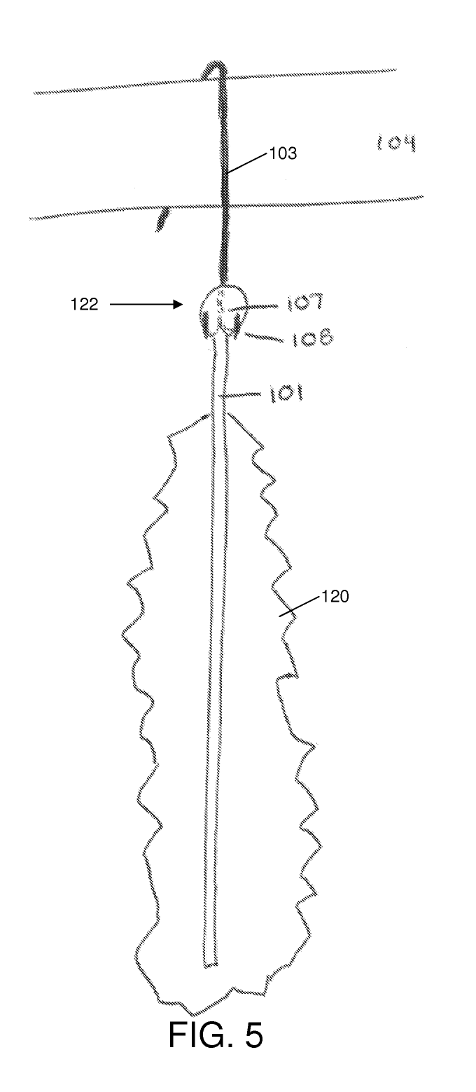

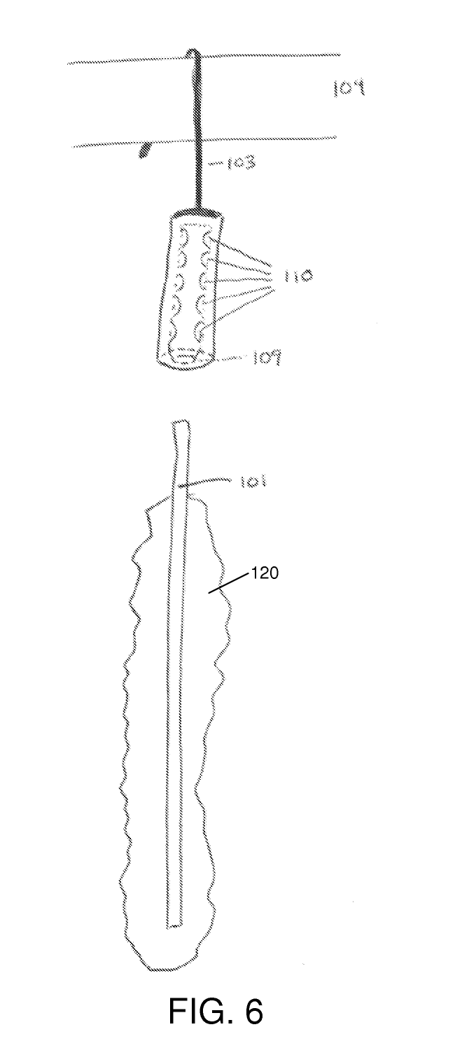

FIG. 5 is a diagram illustrating the use of hook 103 as the attachment mechanism, and the use of a dual-prong hook 122 as connector mechanism 102, capable of suspending stick-based candies 101 that have a ball 107 incorporated into the stick's design. In FIG. 6, by suspending the ball 107 at the end of the stick 101 between dual-prong hooks 108, the stick-based candy can be attached in an inverted position from supporting structure 104.

FIG. 6 is a diagram illustrating integration of a static hook 103 with a female-port attachment mechanism 109, into which the stick 101 can be inserted and suspended therefrom. In FIG. 6, the mechanism 109 employs raised bumpers 110 to grip the stick 101 with suitable pressure and/or friction to enable a stick-based candy to be suspended in an inverted position from a supporting structure 104. The mechanism is configured to provide suitable force so that the stick 101 of any suitable stick-based candy can be unplugged from female-port attachment mechanism 109 with a gentle tug, and the like.

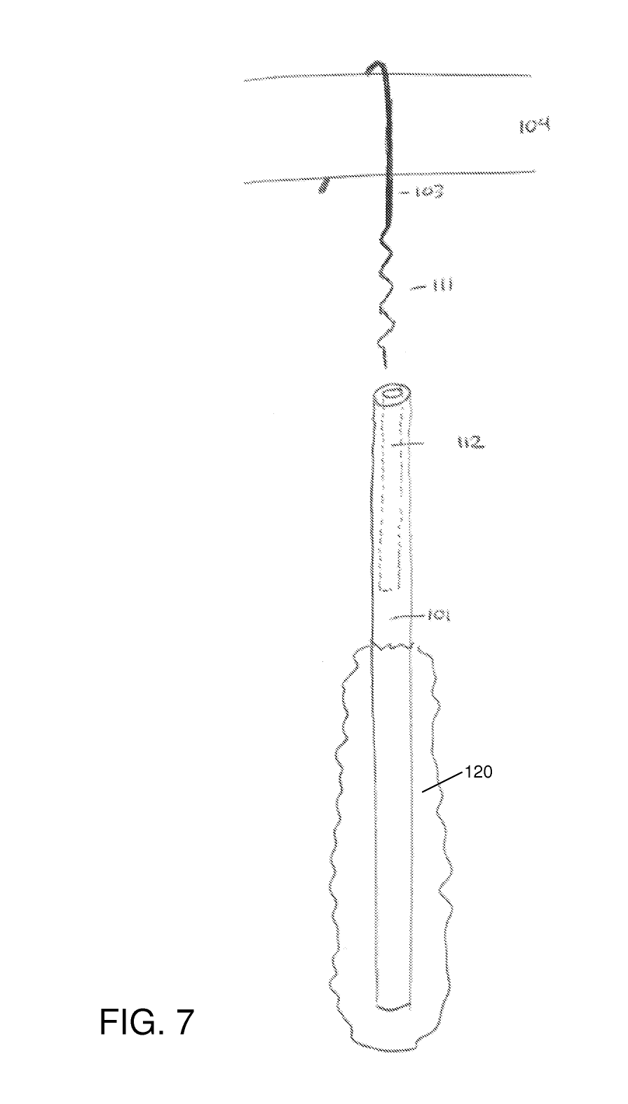

FIG. 7 is a diagram illustrating the integration of a hook 103 with a male attachment mechanism 111, including a straight or slightly wavy pin that can be inserted into a hollow tube 112 within the stick 101 of suitable stick-based candies. In FIG. 7, attachment mechanism 111 employs friction between the male attachment mechanism 111 and the sides of hollow tube 112 to enable the stick-based candies to be securely suspended against the force of gravity, in an inverted position, from a supporting structure 104. The mechanism is configured provide suitable force so that the stick 101 of any suitable stick-based candy can be easily unplugged from the male attachment mechanism 111 with a gentle tug, and the like.

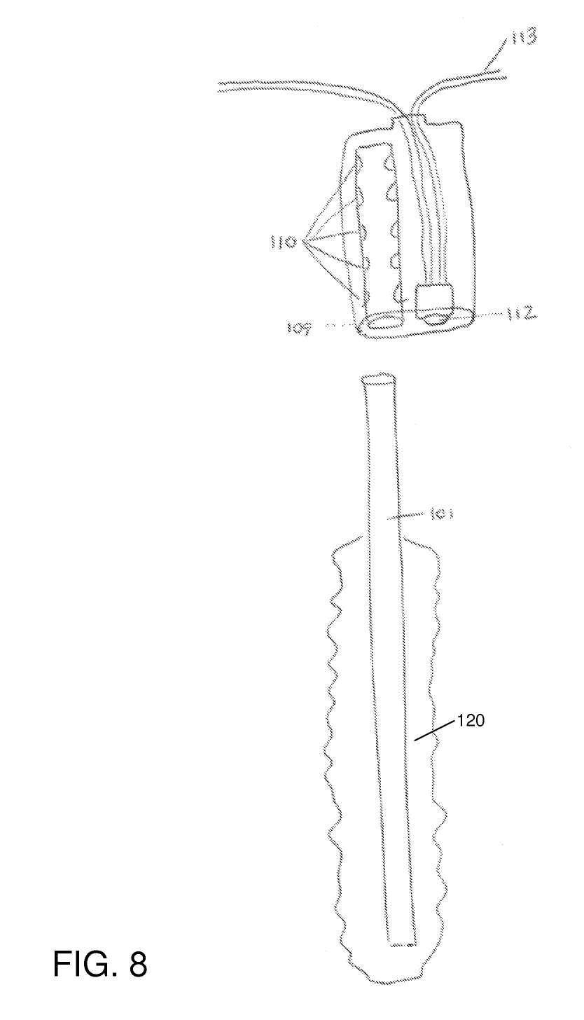

FIG. 8 is a diagram illustrating a female-port attachment mechanism 109 integrated immediately adjacent to each light 112 (or cluster of lights) in a string of powered lights 113. In FIG. 8, the attachment mechanism allows for a string of edible stick-based candies to be hung in an inverted, ornamental fashion, each illuminated from above by light(s) 112. In this configuration, each light or cluster of lights 112 on the string 113 is configured adjacent to or surrounding the attachment port 109 that mates with stick 101, and where the female connector mechanism 109 uses the raised bumpers 110, adhesive, gravity and/or friction, and the like, to hold the candy stick with enough force to allow it to be hung upside down ornamentally. The mechanism is configured so that the weight of the candy is not so great as to allow for gravity to pull the candy stick out of the female port 109, but also loosely enough that the candy stick 101 can be pulled out of the female port 109 with a gentle tug, and the like.

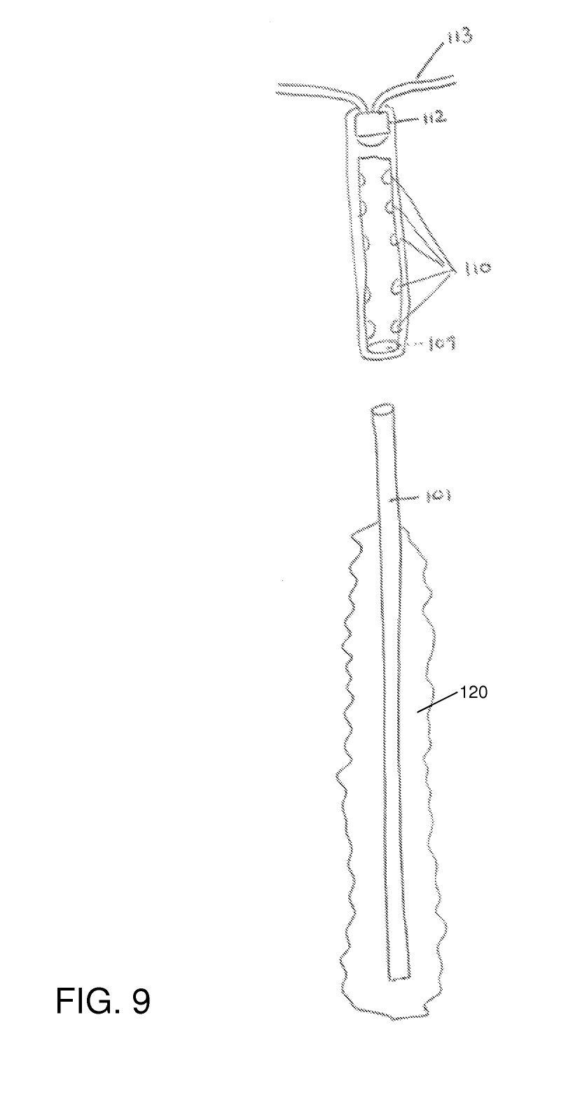

FIG. 9 is a diagram illustrating how an attachment mechanism can be integrated within each lighting unit 112 in a string of powered lights 113. In FIG. 9, the attachment mechanism allows for a string of edible stick-based candies constructed on stick 101 to be hung in an ornamental fashion and illuminated from within. The stick 101 can be constructed of a light-conducting material, such as plastics, fibers, fiber optics, and the like. In this configuration, each lighting unit 112 projects light through the center of the candy's stick 101, and immediately beneath the lighting unit 112. In a further illustrative embodiment, a programmable control box (not shown), as is well known in the art, can be employed and configured to allow for programming of color, brightness, and patterns of lights, and the like, transmitted by the lighting unit 112. The female connector mechanism 109 uses the raised bumpers 110, adhesive, gravity, and/or friction, and the like, to hold the candy stick 101 with enough force to allow it to be hung upside down ornamentally. The mechanism is configured so that the weight of the candy is not so great as to allow for the candy stick to fall off the attachment mechanism, but also loosely enough that the candy stick 101 can be pulled off the attachment mechanism with a gentle tug, and the like.

While the present inventions have been described in connection with a number of illustrative embodiments, and implementations, the present inventions are not so limited, but rather cover various modifications, and equivalent arrangements, which fall within the purview of the appended claims.

What is claimed is:

1. An ornamental device, the device comprising:
a string of electrically-illuminated lights having a plurality of lighting units; and
respective attachment mechanisms coupled to each of the lighting units of the string of electrically-illuminated lights and configured to securely hold ends of sticks of stick-based candies therein and incorporated into each lighting unit on the string of electrically-illuminated lights.

2. The device of claim 1, wherein the sticks of the stick-based candies are made from a light-conducting material; and
each of the lighting units and the respective attachment mechanisms are configured so that light from the lighting units is projected through the sticks of stick-based candies to illuminate the sticks.

3. The device of claim 2, further comprising:
a programmable control box configured to allow for programming of color, brightness, and patterns of lights transmitted by the lighting units.
